(19) United States
(12) Patent Application Publication
(10) Pub. No.: US 2017/0130873 A1
(43) Pub. Date: May 11, 2017

(54) CLAMPING ARRANGEMENT

(71) Applicant: Caterpillar Inc., Peoria, IL (US)

(72) Inventors: Mark J. Maggi, Granville, IL (US); Connor S. Widder, Austin, TX (US)

(73) Assignee: Caterpillar Inc., Peoria, IL (US)

(21) Appl. No.: 14/933,340

(22) Filed: Nov. 5, 2015

(51) Int. Cl. F16L 3/137; F16L 3/01

(52) U.S. Cl. CPC F16L 3/137; F16L 3/01

(57) ABSTRACT

A clamp for securing at least one member is provided. The clamp includes at least one encircling portion defining an opening therein. The clamp also includes a locking mechanism extending from the at least one encircling portion. The locking mechanism includes a first portion having at least one projection. The locking mechanism also includes a second portion configured for engagement with the first portion. The second portion includes at least one recess, wherein the at least one projection of the first portion interlocks with the at least one recess based on an engagement of the first portion with the second portion. The clamp also includes a leg portion coupled to the at least one encircling portion. The leg portion is configured to couple the clamp with a coupling surface.

### TECHNICAL FIELD

The present disclosure relates to a clamping arrangement for securing at least one member, and more particularly to a clamp associated with the clamping arrangement.

### BACKGROUND

Machines employed in industries such as construction, mining, and transportation requires routing and/or securing of members such as wires, cables, and the like to one or more machine or component coupling surface. Typically, a clamping arrangement is used to secure the members to the coupling surface. In some examples, a number of clamping arrangements are arranged in series for fixing the member. Each clamping arrangement includes a clip such as, a bowtie clip or a butterfly clip, which is attached to the coupling surface. Further, a zip tie is used to hold the members therein. The zip tie is in turn coupled to the clip. The zip ties are non-reusable and cannot be interchangeably used for different applications. Further, the zip ties do not provide a tight restraint, thereby increasing a probability of loosening of the members from the zip tie.

U.S. Pat. No. 5,474,268 describes a reusable agricultural and industrial tie for securing objects to a fixed structure, such as a tensile wire, and a wooden or metal structure. The reusable tie includes a head portion adapted for securely fastening onto the fixed structure, and a band having two ends coupled to the head portion and forming a generally annular cavity. A clamping assembly is formed in the ends of the generally annular band and has first and second interlocking members for adjustably, securely and fixedly clamping around the objects.

### SUMMARY OF THE DISCLOSURE

In one aspect of the present disclosure, a clamp for securing at least one member is provided. The clamp includes at least one encircling portion defining an opening therein. The clamp also includes a locking mechanism extending from the at least one encircling portion. The locking mechanism includes a first portion having at least one projection. The locking mechanism also includes a second portion configured for engagement with the first portion. The second portion includes at least one recess, wherein the at least one projection of the first portion interlocks with the at least one recess based on an engagement of the first portion with the second portion. Further, a compressive force applied on the locking mechanism allows tightening of the at least one member within the at least one opening. The clamp also includes a leg portion coupled to the at least one encircling portion. The leg portion is configured to couple the clamp with a coupling surface. The leg portion includes a first leg having a first coupling portion. The first coupling portion is configured to couple with a first portion of the coupling surface. The leg portion also includes a second leg having a second coupling portion. The second coupling portion is configured to couple with a second portion of the coupling surface.

In another aspect of the present disclosure, a clamping arrangement for clamping of at least one member is provided. The clamping arrangement includes a clip including a first portion and a second portion. The clamping arrangement also includes a clamp configured to couple with the clip. The clamp includes at least one encircling portion defining an opening therein. The clamp also includes a locking mechanism extending from the at least one encircling portion. The locking mechanism includes a first portion having at least one projection. The locking mechanism also includes a second portion configured for engagement with the first portion. The second portion includes at least one recess, wherein the at least one projection of the first portion interlocks with the at least one recess based on an engagement of the first portion with the second portion. Further, a compressive force applied on the locking mechanism allows tightening of the at least one member within the at least one opening. The clamp also includes a leg portion coupled to the at least one encircling portion. The leg portion is configured to couple the clamp with the clip. The leg portion includes a first leg having a first coupling portion. The first coupling portion is configured to couple with a first portion of the clip. The leg portion also includes a second leg having a second coupling portion. The second coupling portion is configured to couple with a second portion of the clip.

In yet another aspect of the present disclosure, a method of clamping at least one member within a clamp is provided. The method includes positioning the at least one member within an opening defined by an encircling portion of the clamp. The method also includes engaging a first portion of a locking mechanism with a second portion of the locking mechanism to secure the at least one member within the opening. The method further includes applying a compressive force on the locking mechanism of the clamp to tighten the at least one member within the encircling portion. The method includes coupling a leg portion of the clamp with a coupling surface, based on the application of the compressive force.

Other features and aspects of this disclosure will be apparent from the following description and the accompanying drawings.

### BRIEF DESCRIPTION OF THE DRAWINGS

FIG. 1 is a perspective view of a portion of an exemplary machine, and a member retained on a surface of the portion with a number of clamping arrangements, according to one embodiment of the present disclosure;

FIG. 2 is a perspective view of a single clamping arrangement having a clip and an exemplary clamp, according to one embodiment of the present disclosure;

FIG. 3 is a perspective view of the clamp of FIG. 2;

FIGS. 4 and 5 are perspective views of the clamp, according to various embodiment of the present disclosure; and

FIG. 6 is a flowchart for a method of clamping the member within the clamp.

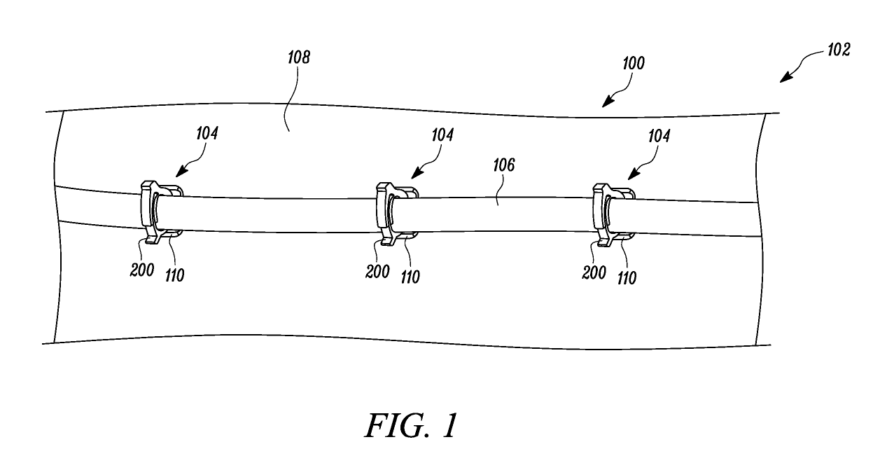

### DETAILED DESCRIPTION

Wherever possible, the same reference numbers will be used throughout the drawings to refer to the same or the like parts. FIG. 1 illustrates a portion 100 of an exemplary machine 102, according to one embodiment of the present disclosure. The portion 100 may belong to any one of a frame of the machine 102, an operator cabin of the machine 102, and engine enclosure of the machine 102, and the like, without any limitations. Further, the machine 102 may embody any tracked or wheeled machine including, but not limited to, a wheel loader, an excavator, a shovel, a dozer, a mining truck, an articulated truck, a track type tractor, a forklift, a crane, and so on. In one example, the machine 102 may embody a stationary machine. The machine 102 may be any machine known in the art and associated with industries including, but not limited to, agriculture, transportation, mining, construction, forestry, and material handling.

According to an embodiment of the present disclosure, a number of clamping arrangements 104 are provided. The clamping arrangements 104 are used for coupling a member 106 to the machine 102. In the illustrated embodiment, the member 106 is coupled to a surface 108 of the portion 100 of the machine 102. The clamping arrangements 104 may be used for clamping a flexible member or a rigid member, based on system requirements. The member 106 may embody any of a wire, a hose, a pipe, a cable, a conduit, and the like. In one example, the member 106 may be a wire associated with an electrical system of the machine 102. In another example, the member 106 may embody a hose that allows fluid communication between one or more components of the machine 102.

Referring to the accompanying figure, multiple clamping arrangements 104 are shown coupled to the surface 108. The clamping arrangements 104 are aligned and coupled to the surface 108 so that the member 106 may be received by these clamping arrangements 104. Although the figure illustrates three clamping arrangement 104 coupled to the surface 108, the number of clamping arrangements 104 may vary based on system requirements.

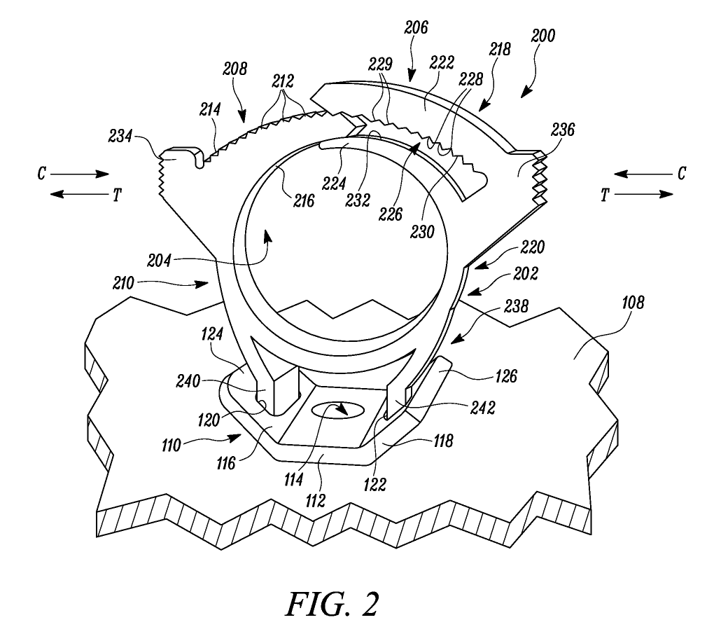

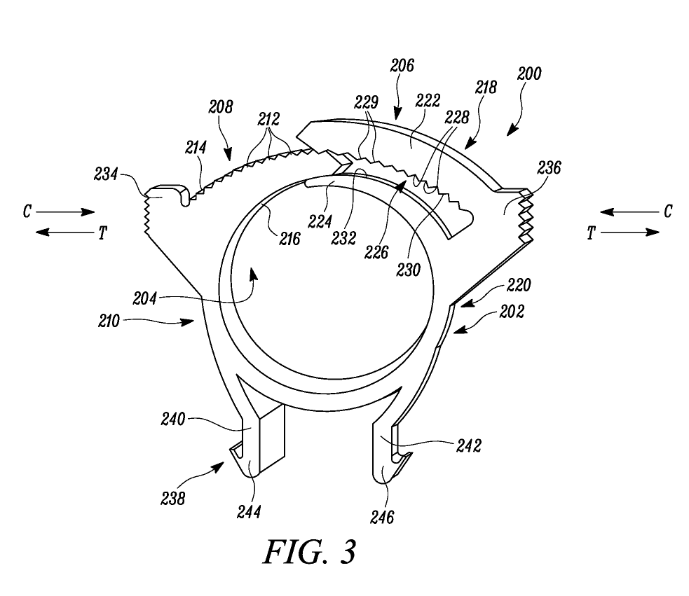

For exemplary purposes, a single clamping arrangement 104 will now be described in detail with respect to FIGS. 2 and 3. However, it should be noted that the description provided is equally applicable to each of the clamping arrangements 104 illustrated in FIG. 1. Referring to FIG. 2, the clamping arrangement 104 includes a clip 110 and a clamp 200. The clip 110 is embodied as a butterfly clip. Alternatively, the clip 110 may embody a bowtie clip, or any other clip known in the art. The clip 110 is fixedly coupled to the surface 108 of the machine 102. In one example, the clip 110 may be welded to the surface 108. Alternatively, a different coupling process, such as soldering or brazing may be used to couple the clip 110 with the surface 108. Further, the clip 110 may be fastened to the surface 108 using mechanical fasteners such as bolts, pins, rivets, screws, and the like.

The clip 110 includes a base portion 112. The base portion 112 includes an opening 114. In an example where the clip 110 is bolted to the surface 108, the opening 114 of the clip 110 is aligned with an opening provided in the surface 108 to receive the mechanical fastener. Further, the clip 110 includes a first portion 116 hereinafter interchangeably referred to as the first wing section 116 and a second portion 118 hereinafter interchangeably referred to as the second wing section 118. The first and second wing sections 116, 118 extend from the base portion 112 of the clip 110. The first and second wing sections 116, 118 are provided at an angle with respect to the base portion 112. Each of the first and second wing sections 116, 118 includes an opening 120, 122. In one example, the openings 120, 122 are embodied as rectangular openings. The clip 110 may be made of a metal or non-metal, without limiting the scope of the present disclosure.

The clamping arrangement 104 also includes the clamp 200. Referring to FIG. 3, the clamp 200 receives and secures a portion of the member 106. The clamp 200 includes an encircling portion 202. The encircling portion 202 is circular in shape. However, a shape of the encircling portion 202 may vary, and is dependent on a shape of the member 106. The encircling portion 202 defines an opening 204. The opening 204 may be a circular opening. In alternate examples, the shape of the opening 204 may be square or rectangular, based on the shape of the member 106. Further, the clamp 200 includes a locking mechanism 206. The locking mechanism 206 extends from the encircling portion 202. The locking mechanism 206 allows insertion of the member 106 within the opening 204 of the encircling portion 202. Further, the locking mechanism 206 holds and retains the member 106 within the opening 204 of the encircling portion 202.

The locking mechanism 206 includes a first portion 208. The first portion 208 extends from a first end 210 of the encircling portion 202. The first portion 208 is embodied as a tongue. The first portion 208 includes at least one projection 212. In this example, the first portion 208 includes a number of projections 212 that are embodied as a number of teeth 212. The number of projections 212 is hereinafter interchangeably referred to as the number of teeth 212. The number of teeth 212 extends from an outer surface of the first portion 208. The outer surface may include any one of an upper surface 214 or a lower surface 216 of the first portion 208. In the illustrated embodiment, the number of teeth 212 extends from the upper surface 214 of the first portion 208. In one example, the number of teeth 212 may be provided along the entire upper surface 214 of the first portion 208. In an alternate example, the number of teeth 212 may be provided on the lower surface 216 of the first portion 208, without any limitations.

The locking mechanism 206 also includes a second portion 218. The second portion 218 extends from a second end 220 of the encircling portion 202. The first portion 208 engages with the second portion 218 for retention of the member 106 within the opening 204 of the encircling portion 202. The second portion 218 includes a first tongue 222 and a second tongue 224. The first and second tongues 222, 224 are vertically spaced apart from each other. A groove 226 of the second portion 218 is defined between the first and second tongues 222, 224. The groove 226 is adapted to receive the first portion 208 of the locking mechanism 206 when the first portion 208 is in engagement with the second portion 218.

The second portion 218 includes at least one recess 228. In this example, the second portion 218 includes a number of recesses 228 that are defined by a number of teeth 229. The number of teeth 229 is provided on an inner surface 230 of the first tongue 222. In another example, where the number of teeth 212 is provided on the lower surface 216 of the first portion 208, the number of teeth 229 is provided on an inner surface 232 of the second tongue 224.

As shown in FIG. 2, the number of teeth 212 provided on the upper surface 214 of the first portion 208 interlocks with the number of teeth 229 provided on the inner surface 230 of the first tongue 222 during the engagement of the first portion 208 with the second portion 218. When a compressive force “C” is applied on the locking mechanism 206, the first and second portion 208, 218 move towards each other along a direction of application of the compressive force “C”. Based on the compressive force “C”, the first portion 208 engages with the second portion 218, which in turn allows tightening of the member 106 within the opening 204. As the first portion 208 engages with the second portion 218, the number of teeth 212 of the first portion 208 interlocks with the number of teeth 229 of the second portion 218 which further allows secure retention and tightening of the member 106 within the opening 204.

The compressive force “C” referred to herein is applied on a first lever 234 and a second lever 236 of the locking mechanism 206. The first lever 234 extends from the first portion 208 of the locking mechanism 206. Whereas, the second lever 236 extends from the second portion 218 of the locking mechanism 206. A diameter of the opening 204 may be varied by applying a tensile force “T” or the compressive force “C” on the first and second levers 234, 236 of the locking mechanism 206. More particularly, the diameter of the opening 204 may be reduced by applying the compressive force “C” on each of the first and second levers 234, 236. Further, the tensile force “T” may be applied on the first and second levers 234, 236 to increase the diameter of the opening 204.

Referring now to FIGS. 2 and 3, the clamp 200 includes a leg portion 238. The leg portion 238 couples the clamp 200 with the clip 110. The leg portion 238 is coupled to the encircling portion 202 and extends therefrom. The leg portion 238 includes a first leg 240 and a second leg 242. The first leg 240 extends from the first end 210 of the encircling portion 202. The first leg 240 includes a first coupling portion 244 (see FIG. 3). The first coupling portion 244 couples the first leg 240 with the first wing section 116 of the clip 110. In one example, the first coupling portion 244 is U-shaped. The first coupling portion 244 passes through the opening 120 and interlocks with an upper member 124 of the first wing section 116 in order to couple the first leg 240 with the first wing section 116.

Further, the second leg 242 of the leg portion 238 extends from the second end 220 of the encircling portion 202. The second leg 242 includes a second coupling portion 246 (see FIG. 3). In order to couple the clamp 200 with the clip 110, the second coupling portion 246 of the second leg 242 engages with the second wing section 118 of the clip 110. In one example, the second coupling portion 246 is U-shaped. The second coupling portion 246 passes through the opening 122 and interlocks with an upper member 126 of the second wing section 118 in order to couple the second leg 242 with the second wing section 118. In another example, the first and second coupling portion 244, 246 may be V-shaped, without any limitations.

When the compressive force “C” is applied on the first and second levers 234, 236, the first and second legs 240, 242 extends in a direction that is opposite to the direction of the application of the compressive force “C”. Based on the extension, the first and second coupling portions 244, 246 couple with the first wing section 116 and the second wing section 118 of the clip 110 respectively.

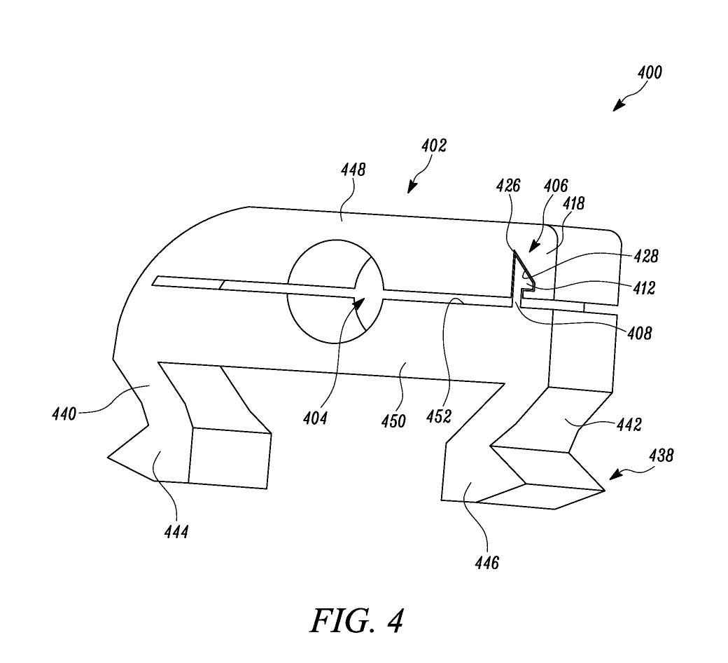

FIG. 4 illustrates an alternate design of the clamp 400. The clamp 400 includes the encircling portion 402. The encircling portion 402 includes an upper portion 448 and a base portion 450, such that the opening 404 is formed between the upper portion 448 and the base portion 450. Further, the locking mechanism 406 of the clamp 400 includes a first portion 408. The first portion 408 extends in a perpendicular direction from an upper surface 452 of the base portion 450. The first portion 408 includes a projection 412. In the illustrated embodiment, the first portion 408 includes a single projection 412. However, the first portion 408 may include more than one projection 412, based on system requirements. For example, the first portion 408 may include a number of projections 412 similar to the number of teeth 212 provided on the first portion 208 of the clamp 200 shown in FIGS. 2 and 3.

The locking mechanism 406 of the clamp 400 includes a second portion 418. The second portion 418 includes a groove 426. Further, the second portion 418 also includes a recess 428 extending from an inner surface defined by the groove 426. In the illustrated embodiment, the second portion 418 includes a single recess 428. However, the second portion 418 may include more than one recess 428, based on system requirements. In one example, the second portion 418 may include a number of recesses 428 defined by a number of teeth similar to the recesses 228 defined by the number of teeth 229 provided on the second portion 218 of the clamp 200 shown in FIGS. 2 and 3.

The clamp 400 includes the leg portion 438. The leg portion 438 includes the first leg 440 and the second leg 442. The first and second legs 440, 442 couple with the first wing section 116 and the second wing section 118 of the clip 110. More particularly, the first coupling portion 444 and the second coupling portion 446 of the first and second legs 440, 442 couple with the first and second wing sections 116, 118 of the clip 110 respectively. The first coupling portion 444 and the second coupling portion 446 of the first and second legs 440, 442 are V-shaped.

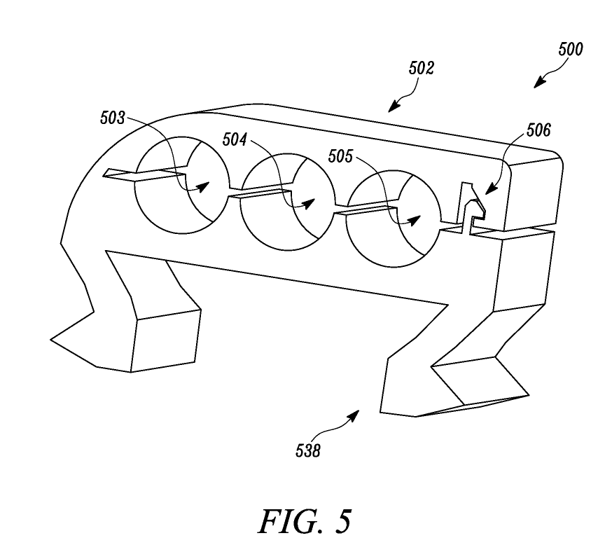

Although the clamp 400 illustrated in FIG. 4 includes the single opening 404 defined by the encircling portion 402, a number of the openings defined by the encircling portion 402 may vary based on system requirements. FIG. 5 is a perspective view illustrating the clamp 500, according to another embodiment of the present disclosure. The clamp 500 includes the encircling portion 502 that defines three openings 503, 504, 505. The openings 503, 504, 505 may receive individual members. The three openings 503, 504, 505 are disposed adjacent to each other. It should be noted that a design of the locking mechanism 506 and the leg portion 538 of the clamp 500 is similar to a design of the locking mechanism 406 and the leg portion 438 shown in FIG. 4.

The clamps 200, 400, 500 may be made of a flexible material. In one example, the clamp 200, 400, 500 may be made of a non-metallic material such as plastics. In another example, the clamp 200, 400, 500 may be made of a metallic material. In such an example, the clamp 200, 400, 500 may be made of a type of steel, such as stainless steel, spring steel, etc. Further, the clamp 200, 400, 500 may also be made of aluminum, without any limitations.

The clamp 200, 400, 500 of the present disclosure may be used in applications other than construction machines. The clamp 200, 400, 500 can be used in association with any product that has electrical, fluid, or air line routings. The clamp 200, 400, 500 may be used in a wide variety of applications including, but not limited to, industrial applications, medical applications, automotive applications, recreational applications, electrical panels and enclosure, various industrial, household, and commercial appliances, and the like.

### INDUSTRIAL APPLICABILITY

The present disclosure relates to the clamp 200, 400, 500 for securing one or more member 106 associated with a wide variety of applications. The locking mechanism 206, 406, 506 of the clamp 200, 400, 500 allows simplified positioning and securing of the member 106 within the clamp 200, 400, 500. When the compressive force “C” is applied to the locking mechanism 206, 406, 506, the member 106 tightens within the encircling portion 202, 402, 502 of the clamp 200, 400, 500. Further, on account of the compressive force “C”, the leg portion 238, 438, 538 tightens inside the clip 110. The leg portion 238, 438, 538 of the clamp 200, 400, 500 is designed to fit snuggly into the clip 110 when the clamp 200, 400, 500 is coupled to the clip 110.

The clamp 200, 400, 500 is embodied as a multi range snap locking clamp that can accommodate the member 106 and/or the rigid member of various dimensions. The clamp 200, 400, 500 provides a reusable solution for securing of the member 106. Further, the clamp 200, 400, 500 provides improved restraint to the member 106, thereby reducing the possibility of loosening of the member 106 from the clamp 200, 400, 500. The clamp 200, 400, 500 provides a cost effective solution for securing of the member 106.

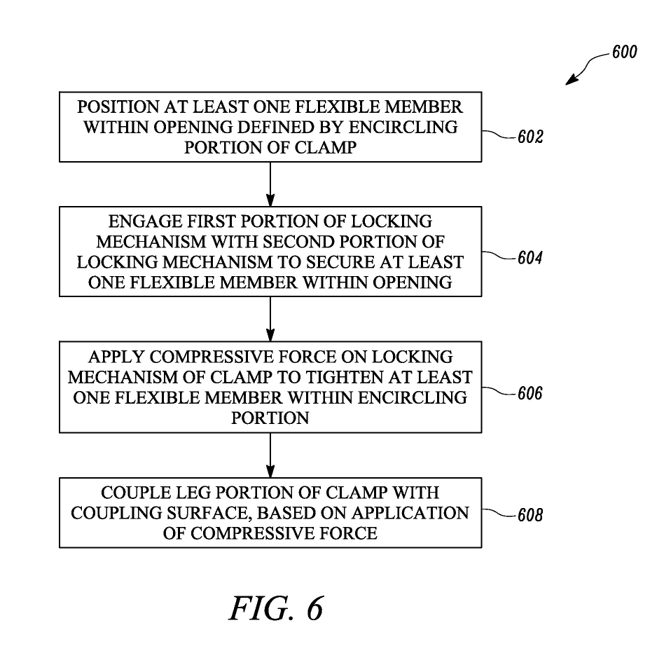

FIG. 6 is a flowchart for a method 600 of clamping the member 106 within the clamp 200, 400, 500. The method 600 will now be explained in reference to the clamp 200 shown in FIGS. 2 and 3. However, it should be noted that the method 600 is equally applicable to clamping of the member 106 within the clamp 400, 500 shown in FIGS. 4 and 5 respectively.

At step 602, the member 106 is positioned within the opening 204 defined by the encircling portion 202 of the clamp 200. The diameter of the opening 204 of the encircling portion 202 is varied based on the application of the tensile force “T” on the locking mechanism 206 or the application of the compressive force “C” on the locking mechanism 206.

At step 604, the first portion 208 of the locking mechanism 206 is engaged with the second portion 218 of the locking mechanism 206 to secure the member 106 within the opening 204. During the engagement, the first portion 208 of the locking mechanism 206 is received within the groove 226 defined in the second portion 218. In one example, the number of teeth 212 provided on the upper surface 214 of the first portion 208 is interlocked with the number of teeth 229 provided on the inner surface 230 of the second portion 218 based on the receipt of the first portion 208 within the groove 226 of the second portion 218. For the clamp 400, the projection 412 of the first portion 408 is interlocked with the recess 428 of the second portion 418 based on the receipt of the first portion 408 within the groove 426 of the second portion 418 (see FIG. 4).

At step 606, the compressive force “C” is applied on the locking mechanism 206 of the clamp 200 to tighten the member 106 within the encircling portion 202. The compressive force “C” is applied on each of the first lever 234 and the second lever 236. At step 608, the leg portion 238 of the clamp 200 is coupled with the clip 110, based on the application of the compressive force “C”. More particularly, the first leg 240 of the leg portion 238 is coupled with the first wing section 116 of the clip 110 and the second leg 242 of the leg portion 238 is coupled with the second wing section 118 of the clip 110, based on the application of the compressive force “C”.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A clamp for securing at least one member, the clamp comprising:
at least one encircling portion defining an opening therein;
a locking mechanism extending from the at least one encircling portion, the locking mechanism comprising:
a first portion having at least one projection; and
a second portion configured for engagement with the first portion, the second portion including at least one recess, wherein the at least one projection of the first portion interlocks with the at least one recess based on an engagement of the first portion with the second portion,
wherein a compressive force applied on the locking mechanism allows tightening of the at least one member within the at least one opening; and
a leg portion coupled to the at least one encircling portion, the leg portion configured to couple the clamp with a coupling surface, the leg portion comprising:
a first leg having a first coupling portion, the first coupling portion configured to couple with a first section of the coupling surface; and
a second leg having a second coupling portion, the second coupling portion configured to couple with a second section of the coupling surface, wherein each of the first coupling portion of the first leg and the second coupling portion of the second leg is U-shaped.

2. The clamp of claim 1, wherein the locking mechanism further includes:
a first lever extending from the first portion of the locking mechanism; and
a second lever extending from the second portion of the locking mechanism,
wherein the compressive force is applied on each of the first and second levers of the locking mechanism to tighten the at least one member within the opening of the encircling portion.

3. The clamp of claim 2, wherein the application of the compressive force on the first and second levers causes each the first leg and the second leg to couple with the first section and the second section of the coupling surface respectively.

4. The clamp of claim 1, wherein the second portion includes a first tongue and a second tongue, such that a groove is defined between the first and second tongues, the groove configured to receive the first portion when the first portion is in engagement with the second portion.

5. The clamp of claim 4, wherein a plurality of teeth provided on an outer surface of the first portion is configured to interlock with a plurality of teeth provided on an inner surface of at least one of the first tongue and the second tongue during the engagement of the first portion with the second portion.

6. The clamp of claim 1, wherein a diameter of the opening of the encircling portion is varied based on at least one of an application of a tensile force on the locking mechanism and the application of the compressive force on the locking mechanism.

7. The clamp of claim 1, wherein either the first portion or second portion includes a tapered configuration.

8. A clamping arrangement for clamping of at least one member, the clamping arrangement comprising:
a clip including a base portion, a first section and a second section, wherein the first section and second section extend from the base portion at an angle; and
a clamp configured to couple with the clip, the clamp comprising:
at least one encircling portion defining an opening therein;
a locking mechanism extending from the at least one encircling portion, the locking mechanism comprising:
a first portion having at least one projection; and
a second portion configured for engagement with the first portion, the second portion including at least one recess, wherein the at least one projection of the first portion interlocks with the at least one recess based on an engagement of the first portion with the second portion,
wherein a compressive force applied on the locking mechanism allows tightening of the at least one member within the at least one opening; and
a leg portion coupled to the at least one encircling portion, the leg portion configured to couple the clamp with the clip, the leg portion comprising:
a first leg having a first coupling portion, the first coupling portion configured to couple with a first section of the clip; and
a second leg having a second coupling portion, the second coupling portion configured to couple with a second section of the clip.

9. The clamping arrangement of claim 8, wherein the locking mechanism further includes:
a first lever extending from the first portion of the locking mechanism; and
a second lever extending from the second portion of the locking mechanism,
wherein the compressive force is applied on each of the first and second levers of the locking mechanism to tighten the at least one member within the opening of the encircling portion.

10. The clamping arrangement of claim 9, wherein the application of the compressive force on the first and second levers causes each the first leg and the second leg to couple with the first section and the second section of the clip respectively.

11. The clamping arrangement of claim 8, wherein the second portion includes a first tongue and a second tongue, such that a groove is defined between the first and second tongues, the groove configured to receive the first portion when the first portion is in engagement with the second portion.

12. The clamping arrangement of claim 11, wherein a plurality of teeth provided on an outer surface of the first portion is configured to interlock with a plurality of teeth provided on an inner surface of at least one of the first tongue and the second tongue during the engagement of the first portion with the second portion.

13. The clamping arrangement of claim 8, wherein a diameter of the opening of the encircling portion is varied based on at least one of an application of a tensile force on the locking mechanism and the application of the compressive force on the locking mechanism.

14. A method of clamping at least one member within a clamp, the method comprising:
positioning the at least one member within an opening defined by an encircling portion of the clamp;
engaging a first portion of a locking mechanism with a second portion of the locking mechanism to secure the at least one member within the opening;
applying a compressive force on the locking mechanism of the clamp to tighten the at least one member within the encircling portion;
coupling a leg portion of the clamp with a coupling surface, based on the application of the compressive force; and
providing a coupling surface by attaching a clip to a surface of the machine.

15. The method of claim 14, wherein the compressive force is applied on each of a first lever and a second lever of the locking mechanism.

16. The method of claim 14, wherein the engaging step includes:
receiving the first portion of the locking mechanism within a groove defined in the second portion.

17. The method of claim 16, wherein the engaging step includes:
interlocking at least one projection of the first portion with at least one recess of the second portion based on the receipt of the first portion within the groove of the second portion.

18. The method of claim 16, wherein the engaging step includes:
interlocking a plurality of teeth provided on an outer surface of the first portion with a plurality of teeth provided on an inner surface of the second portion based on the receipt of the first portion within the groove of the second portion.

19. The method of claim 14 further comprising:
varying a diameter of the opening of the encircling portion based on at least one of an application of a tensile force on the locking mechanism and the application of the compressive force on the locking mechanism.

20. The method of claim 14, wherein the coupling step includes:
coupling a first leg of the leg portion with a first section of the coupling surface and a second leg of the leg portion with a second section of the coupling surface, based on the application of the compressive force.
